(19) United States
(12) Patent Application Publication
(10) Pub. No.: US 2025/0178091 A1
(43) Pub. Date: Jun. 5, 2025

(54) RECYCLABLE METAL COMPOSITE SHEETS, THEIR USES, AND METHOD OF MANUFACTURE

(71) Applicant: THE PROVOST, FELLOWS, SCHOLARS AND OTHER MEMBERS OF BOARD OF TRINITY COLLEGE DUBLIN, Dublin (IE)

(72) Inventors: Rocco LUPOI, Dublin 15 (IE); Ramesh Babu PADAMATI, Dublin 15 (IE); Ramsankar SENTHAMARAIKANNAN, Cabra (IE); William ABBOTT, Dublin 9 (IE); Jonathan CASSIDY, Dublin (IE); Greg MC AVOY, Wicklow (IE); Sean MC CONNELL, Meath (IE); John CONNOLLY, Meath (IE)

(73) Assignee: THE PROVOST, FELLOWS, SCHOLARS AND OTHER MEMBERS OF BOARD OF TRINITY COLLEGE DUBLIN, Dublin (IE)

(21) Appl. No.: 18/840,433

(22) PCT Filed: Feb. 22, 2023
(86) PCT No.: PCT/EP2023/054383

§ 371 Date: Aug. 21, 2024

(30) Foreign Application Priority Data
Feb. 22, 2022 (EP) 22158106.9

(51) Int. Cl. B22F 10/73; B22F 1/102; B22F 10/10; B22F 10/64; B33Y 10/00; B33Y 40/20; B33Y 70/10; B33Y 80/00

(52) U.S. Cl. CPC B22F 10/73; B22F 1/102; B22F 10/10; B22F 10/64; B33Y 10/00; B33Y 40/20; B33Y 70/10; B33Y 80/00

(57) ABSTRACT

A recyclable and flexible metal powder composite sheet, the sheet comprising at least one metal powder and at least one polymer, wherein the polymer fraction of the composite sheet is non-homologous in cross-section.

### FIELD OF THE INVENTION

The invention relates to recyclable composite sheets and a method of making the same. In one aspect, the composite sheets that can be used to provide coatings over substrate materials or pre-existing parts.

### BACKGROUND TO THE INVENTION

Additive manufacturing (AM) is an emerging advanced manufacturing technology that manufactures 3D components in a layer-by-layer manner, which can be used for the printing of near-net-shape and bespoke components in industry, e.g., turbine blade and copper combustion chamber. However, the conventional metal AM methods have inherent limitations such as long, labour intensive, clean-up times when switching from one to another material, so they tend to be limited to the printing of single-material components.

Selective laser melting (SLM), also known as Laser Powder Bed Fusion (LPBF), is an additive manufacturing (AM) technique designed to assemble 3-dimensional metal components. A layer of powdered material (generally metallic but ceramic or composite powders are also used) is laid out on a base plate, and a high-powered laser welds together the powder in a pre-designed pattern. A new layer of powder is then spread on top of the previous layer, and the process occurs again. After the final pattern has been welded, the excess powder is removed, revealing the completed part.

One of the most pertinent issues with LPBF, however, is that current AM systems are only capable of fabricating parts using a single material at a time. There have been multiple proposed solutions for this problem. Several of these solutions take the form of depositing the powder with different nozzles, using a multi-component powder hopper to distribute different powder mixes from the same nozzle, to using a micro-vacuum to remove material at specific areas and replacing it with the desired new material. Other systems have been developed to use an electrostatic charge-based powder delivery systems and avoiding the use of vacuum technology entirely. These approaches, however, will potentially add significant time-delay to the manufacturing process, and do nothing to resolve the use of loose powders in the manufacturing process. Certain metal powders, such as aluminium, are highly combustible, thus increasing health and safety concerns during processing. When using multiple powders in a single machine, changing the powder material and chamber clean-up is generally an arduous process regardless of the material used, with some commercial LPBF systems having estimated clean-up times of up to two working days.

WO 2020/165193 describes the process of manufacturing a metal powder composite sheet.

It is an object of the subject invention to overcome at least one of the above-referenced problems.

### SUMMARY OF THE INVENTION

To solve these issues, a novel metal powder-polymer composite sheet is provided in place of the use of loose metal powders for manufacturing metal components. The invention described herein proposes a new metal powder-polymer composite sheet for a disruptive laser-based additive manufacturing—which the Applicant's term Metal Additive Powder in Sheets (‘MAPS’). This is a modified SLM method whereby loose powder (routinely used) is replaced with a flexible metal powder-polymer sheet fed onto the build area using rollers. During the MAPS manufacturing process, the polymer is vaporised, and the metal powders are sintered or fused together when a laser beam is focused on the target area.

In this process, metal powder-polymer composite sheets comprising composite materials (consisting of polymer and metal powder) are fabricated via solvent casting and loaded onto a roller mechanism, which positions the sheet over the build plate. A laser then scans over the sheet in the required layer shape, depositing welded metal from the metal powder-polymer composite sheet onto the build plate. The roller mechanism then moves the metal powder-polymer composite sheet onto an unprocessed area of the sheet, and the next layer is printed.

This MAPS approach has several distinct advantages over traditional LPBF methods, most of which are due to the use of the metal powder-polymer composite sheet over loose powder. Firstly, the safety of the process is improved considerably since the powder is in a sheet form and the powder cannot become suspended in air (a key condition for powder explosions). Secondly, the cleaning time of the build chamber is reduced dramatically only requiring a quick wipe-down to remove char from the chamber. Thirdly, multi-material printing in a single chamber is more feasible as the printing material can be changed simply by changing the powder sheet used. Fourthly, the overall build-time is reduced as the powder recoating step is replaced by the roller mechanism moving the sheet area, which reduces each layer print time by approximately 1% to 50%. In addition, by changing the cross-section homogeneity of the metal powder-polymer composite sheet, it is possible to control the stiffness or flexibility of the sheet, which helps when the metal powder-polymer composite sheet of the claimed invention is prepared in the form of a roll, and how the roll is handled in the printing machine. Furthermore, the recyclability and flexibility of the metal powder-polymer composite sheet of the claimed invention is more cost effective to use, and can be used in prosumer, portable, and industrial scale printing machines. The metal powder-polymer composite sheet of the claimed invention can also be formed using single materials, multi-materials and complex materials to yield unique and superior products to the consumer and prosumer.

In one aspect, there is provided a recyclable and flexible metal powder-polymer composite sheet, the sheet comprising at least one metal powder and at least one polymer, wherein the metal powder-polymer composite sheet is non-homogenous in cross-section.

In one aspect, there is provided a recyclable and flexible metal powder-polymer composite sheet, the metal powder-polymer composite sheet comprising at least one metal powder and at least one polymer, and wherein the metal powder-polymer composite sheet has an increased polymer to metal powder ratio at a first side when compared to a second side of the metal powder-polymer composites sheet, providing a non-homogenous composition in cross-section.

In one aspect, the recyclable and flexible metal powder-polymer composite is defined as having a surface profilometry (Ra) value of a first side less than about 60% of an Ra value of a second side. The first side of the metal powder-polymer composite sheet is underside or bottom surface of the metal powder-polymer composite sheet. The second side of the metal powder-polymer composite sheet is the top side of the metal powder-polymer composite sheet.

In one aspect, the ratio of the densities of the polymer solution to the metal powder is between about 1:5 gcm⁻³ to about 1:10 gcm⁻³. That is, about 1:5 gcm⁻³, about 1:6 gcm⁻³, about 1:7 gcm⁻³, about 1:8 gcm⁻³, about 1:9 gcm⁻³, or about 1:10 gcm⁻³. Preferably, the ratio of the densities of the polymer to the metal powder in the metal powder-polymer composite sheet is about 1:7 gcm⁻³.

In one aspect, the metal content in the metal powder-polymer composite sheet is between about 80 wt % and about 99 wt %. Preferably, the metal content in the metal powder-polymer composite sheet is between about 92 wt % and about 96 wt %.

In one aspect, the recyclable and flexible metal powder-polymer composite sheet further comprises a removable solvent-resistant surface on the first side thereof. The first side is typically the underside or the bottom surface of the sheet. Preferably, the solvent-resistant surface is selected from polytetrafluoroethylene, polyimide, and polycarbonate.

In one aspect, the polymer is selected from polycaprolactone, cellulose acetate, cellulose ester, polyester, polyurethane, polyethylene, polypropylene, polyvinylchloride (PVC), polyvinylidene fluoride (PVDF), fluoroplastics, polyetheramide (PEBA), polyether amide (for example, the polyether block amide Pebax® 2533 which is a thermoplastic elastomer made of a flexible polyether and a rigid polyamide), polylactic acid (PLA), polycaprolactone (PCL), nitrocellulose, cellulose, cellulose acetate (such as Natureplast ACI 002®, a non-biodegradable, rigid cellulose acetate), polybutylene succinate (PBS), polyhydroxyalkanoate (PHA), and poly (3-hydroxybutyrate-co-3-hydroxyhexanoate).

The recyclable and flexible metal powder-polymer composite sheet of any one of the preceding claims, wherein the metal powder is selected from stainless steel, tungsten, titanium, titanium alloys, aluminium, aluminium alloys, copper, nickel, nickel alloys, super alloys, high entropy alloys, cobalt-chrome, barium, molybdenum, NiTi (nitilon), NiTi alloys, other metallic materials (such as Silver, Gold, Platinum, Lithium, Beryllium, Magnesium, Zinc, Zirconium, Niobium, Tungsten, Tin, Lead, and their alloys), ceramic materials, metal-ceramic composites, metal-diamond composites, tantalum, tantalum carbide, and combinations thereof.

In one aspect, the recyclable and flexible metal powder-polymer composite sheet described above is used as a thermal interface material, wherein the composite sheet acts as a thermally active material to aid heat transfer between adjoining parts.

In one aspect, the first side of the metal powder-polymer composite sheet is higher in polymer content when compared to the second side of the metal powder-polymer composite sheet.

In one aspect, there is provided a recyclable and flexible, metal powder-polymer composite sheet, the metal powder-polymer composite sheet comprising at least one metal powder and at least one polymer, wherein the metal powder-polymer composite sheet has an increased polymer to metal powder ratio at a first side of the metal powder-polymer composite sheet when compared to a second side providing a non-homogenous composition in cross-section, and wherein the first side of the metal powder-polymer composite sheet has a surface roughness (Ra) value of less than about 60% of a higher Ra value of the second side of the metal powder-polymer composite sheet.

In one aspect, the recyclable and flexible metal powder-polymer composite sheet described above is used in the manufacture of multi-material parts. Examples of the multi-material part include a piece of jewellery (a ring, a necklace, a bracelet, and the like, (for example, printing gold on nickel)), a coated cutting tool (the coating would be harder and have a higher wear resistance and/or temperature resistance versus the core material, such as a drill bit, a turning cutting tool, a mill end, an injection moulding mould and mould pins; for example, titanium nitride coated on steel, which adds hardness and maintains a level of ductility), biomedical implants (such as stents, intramedullary nail systems, artificial joints (hip, knee, shoulder, and the like), for example, titanium or steel coated with HAP (hydroxyapatite) composites to increase biocompatibility).

In one aspect there is provided a method of manufacturing the recyclable and flexible metal powder-polymer composite sheet described above, the method comprising the steps of:
dissolving between about 8 wt % and about 50 wt % of a polymer in an organic solvent to form a polymer solution;
dispersing at least one metal powder in the polymer solution in a ratio of polymer solution to metal powder of about 10 ml:2 g (v/w) to about 2 ml:9 g (v/w) to form a metal-dispersed solution;
casting the metal-dispersed solution on to a casting surface; and
drying the cast metal-dispersed solution to form the recyclable and flexible metal powder-polymer composite sheet.

In one aspect, the organic solvent is selected from acetone, chloroform, N-methyl formamide, tetrahydrofuran, cyclohexane, dimethylacetamide, dimethylsulphoxide, dimethylformamide, butanol, ethanol, methyl ethyl ketone, and diacetone alcohol.

In one aspect, the polymer is selected from polycaprolactone, polytetrafluoroethylene, cellulose acetate, cellulose ester, polyester, polyurethane, polyethylene, polypropylene, polyvinylchloride (PVC), polyvinylidene fluoride (PVDF), fluoroplastics, polyetheramide (PEBA), polyether amide (for example, the polyether block amide Pebax® 2533 which is a thermoplastic elastomer made of a flexible polyether and a rigid polyamide), polylactic acid (PLA), polycaprolactone (PCL), nitrocellulose, cellulose, cellulose acetate (such as Natureplast ACI 002®, a non-biodegradable, rigid cellulose acetate), polybutylene succinate (PBS), polyhydroxyalkanoate (PHA), and poly (3-hydroxybutyrate-co-3-hydroxyhexanoate).

Preferably, the polymer solution is between about 5 wt % and about 30 wt % polycaprolactone in chloroform. Preferably, the polymer solution is about 14 wt % polycaprolactone in chloroform.

Preferably, the polymer solution is between about 5 wt % and about 30 wt % polytetrafluoroethylene in acetone. Preferably, the polymer solution is about 20 wt % polytetrafluoroethylene in acetone.

Preferably, the cast metal dispersed solution is dried at room temperature.

In one aspect, the method further comprises the step of adding the metal powder-polymer composite sheet in a solvent to form a recycled metal powder-polymer solution, casting the recycled metal powder-polymer solution onto the casting surface; and drying the cast recycled metal powder-polymer solution to form the recyclable and flexible metal powder composite sheet.

In one aspect, the metal powder is selected from stainless steel, tungsten, titanium, titanium alloys, aluminium, aluminium alloys, copper, nickel, nickel alloys, super alloys, high entropy alloys, cobalt-chrome, barium, molybdenum, NiTi (nitilon), NiTi alloys, other metallic materials (such as Silver, Gold, Platinum, Lithium, Beryllium, Magnesium, Zinc, Zirconium, Niobium, Tungsten, Tin, Lead, and their alloys), ceramic materials, metal-ceramic composites, metal-diamond composites, tantalum, tantalum carbide, and combinations thereof.

In one aspect, the cast metal-dispersed solution is dried for between 1 and 10 minutes. In other words, the cast metal-dispersed solution is dried for 1 minute, 2 minutes, 3 minutes, 4 minutes, 5 minutes, 6 minutes, 7 minutes, 8 minutes, 9 minutes, or 10 minutes. In one aspect, the cast metal-dispersed solution is dried from between about 2 to about 7 minutes, that is, for 2 minutes, 3 minutes, 4 minutes, 5 minutes, 6 minutes, or 7 minutes.

In one aspect, wherein the at least one metal powder in the polymer solution has a ratio of polymer solution to metal powder of about 10 ml:2 g, 9 ml:3 mlg, 8 ml:4 g, 7 ml:5 g, 6 ml:4 g, 5 ml:5 g, 5 ml:1 mlg, 4 ml:6 g, 3 ml:7 g, 2 ml:8 g, 1 ml:5 g, or 1 ml:9 g. In one aspect, the ratio is 5 ml:1 g (w/v).

In one aspect, the metal is selected from the group comprising stainless steel, tungsten, titanium, titanium alloys, aluminium, aluminium alloys, copper, nickel, nickel alloys, super alloys, high entropy alloys, cobalt-chrome, barium, molybdenum, NiTi (nitilon), NiTi alloys, other metallic materials (such as Silver, Gold, Platinum, Lithium, Beryllium, Magnesium, Zinc, Zirconium, Niobium, Tungsten, Tin, Lead, and their alloys), ceramic materials, metal-ceramic composites, metal-diamond composites, tantalum, tantalum carbide, and combinations thereof.

In one aspect, the recyclable and flexible metal powder-polymer composite sheet described above can be used as a coating, for embellishments, for repairing devices or machines (for example, corroded parts, repairing of an impeller locally corroded due to cavitation, repairing of a damaged turbine blade or mechanical shafts in large food processing valves controlling waste flows).

In one aspect, the recyclable and flexible metal powder-polymer composite sheet described above further comprises a blend of different metals. Blending different metals together in the single sheet allows the user to create different alloys with different compositions and properties to suit the uses requirements. The sheets can also be prepared so that the sheet has distinct areas of different metals or blends of different metals.

In one aspect, there is provided a method for printing an object using the recyclable and flexible metal powder-polymer composite sheet described above, the method comprising the steps of: (i) applying the recyclable and flexible metal powder-polymer composite sheet on a build plate, with the second side of the metal powder-polymer composite sheet facing the build plate; (ii) applying heat to composite sheet until a fusion temperature of the metal powder is achieved; (iii) removing the metal powder-polymer composite sheet which was not affected by the heat application from the area or optionally re-centering an untreated portion of the heated metal powder-polymer composite sheet on the build plate for depositing a further layer of metal; and (iv) adding a new metal powder-polymer composite sheet when the previous metal powder-polymer composite sheet is no longer required, and repeat the steps (i) to (iii) until the object is achieved.

In one aspect, the heat is generated by a heat source selected from an infrared radiation device, a laser, an ion laser, an electron beam, an arc, plasma, an induction heater, a hot plate, or a combination thereof. Preferably, the laser is selected from a CO₂ laser, a 1064 nm infrared Nd: YAG laser, an infrared fibre laser, a diode laser, an argon laser, a krypton laser, an argon/krypton laser, a helium-cadmium laser, a copper vapor laser, a xenon laser, an iodine laser, an oxygen laser, and an excimer laser. Ideally, the power output of the laser is greater than 1 W.

In one aspect, wherein the step (iv) can be replaced with, or followed by step (v), recycling any scraps of the previous metal powder-polymer composite sheet and adding the recycled metal powder-polymer composite sheet when the previous metal powder-polymer composite sheet is no longer required, and repeat the steps (i) to (iii) until the object is achieved.

### Definitions

In the specification, the term “sintering” should be understood to mean to coalesce into a solid or porous mass by means of heating without liquefaction. The term “sintering” or “sintered” is also understood to mean “welding” or “welded”, respectively, and the terms can be used interchangeably.

In the specification, the term “flexible” should be understood to mean that the metal powder-polymer composite sheet can bend or flex easily without breaking.

In the specification, the term “complex structures” should be understood to mean three-dimensional part geometries that cannot easily be manufactured using conventional methods such casting, machining, forging, assembly, etc.

In the specification, the terms “metal”, “weldable metal”, “weldable thermoplastics”, or “weldable plastics” should be understood to mean materials that can be joined together by applying a heat input at the contact interface, achievable also by the inclusion of fillers to facilitate the joining action. In cases where no filler material is added (resistance, electron beam, laser, and some autogenous arc welding), the weldable metal or weldable thermoplastic has the same composition as the parent material. Where filler materials are added to the weld pool, the composition of the weldable metal weldable thermoplastic (plastic) usually differs from that of the parent material. Examples of weldable metals are steel, stainless steel, titanium, titanium alloys (such as Ti64 or Ti grade 5 and 23), aluminium, aluminium alloys (such Al 6061 and Al 7075), copper, nickel, nickel alloys, super alloys (such as Inconel 625 and 718), high entropy alloys (such as FeCoNiCrMn), cobalt-chrome, barium and molybdenum. Examples of weldable plastics are epoxy, silicone, vulcanised rubber, polyester, polyurethane, polyethylene, polypropylene, polyvinylchloride (PVC), polyvinylidene fluoride (PVDF), fluoroplastics, polyetherimide (PEBA), polyether amide 2533, polylactic acid (PLA), polycaprolactone (PCL), nitrocellulose, cellulose, cellulose acetate (such as Natureplast ACI 002), Polybutylene succinate (PBS), polyhydroxyalkanoate (PHA), and poly (3-hydroxybutyrate-co-3-hydroxyhexanoate). Other examples of weldable materials include ceramic-metal composites such as WC—Co and metal-diamond combinations, metal-alumina combinations.

In the specification, the term “build plate” or “metallic build plate” should be understood to mean a surface on which the metal-impregnated polymer sheet or metal-polymer composite is placed on to. The build plate is preferably of the same metal as the powder material, as that will maximise the weldability of the metal-polymer composite. However, the invention is also for multi-material printing, thus combinations of different metals are also possible.

In the specification, the term “Metal Additive Powder in Sheets (or ‘MAPS’) means the metal powder-polymer composite sheets of the claimed invention for use in a disruptive laser-based additive manufacturing system which would replace the powder based LPBF system used in additive manufacturing systems today. Note the term “metal” is not limited to just metal but can also mean ceramics or ceramic composites.

In the specification, the term ‘powder sheet’, ‘metal-polymer sheet’, ‘composite sheet’, ‘metal powder sheet’, ‘metal impregnated polymer sheet’, ‘metal powder-polymer composite sheet’ are interchangeable and refer to the metal powder-polymer composite sheet of the claimed invention.

In the specification, the term “polymer sheet architecture” should be understood to mean the structural features of the polymer sheet which accommodate the insertion of the metal particles within the polymer sheet itself.

In one aspect, the term “surface” of the metal powder-polymer composite sheet should be understood to mean either surface of the sheet, that is, a top side (second side) or an underside (a first side) of the metal powder-polymer composite sheet. The top side is typically metal powder rich (the powder side or topside, having a lower concentration or lower distribution of polymer), while the underside is typically polymer rich (the polymer side or underside, having the largest concentration or distribution of polymer). It is understood that, in the majority of cases, the polymer will sink towards the underside under the force of gravity as the solvent evaporates, while the topside will be primarily well stacked with metal or ceramic or ceramic composites particles. The polymer will maintain contact with the particles in the metal powder-polymer composite sheet providing integrity and structure in the metal powder-polymer composite sheet architecture.

In the specification, the term “integrated” or “embedded” should be understood to mean where a metal particle is integrated with or embedded in the metal powder-polymer composite sheet architecture.

In the specification, the term “recyclable” should be understood to mean to treat or process the leftover, remnants, or residual pieces of metal powder-polymer composite sheets of the claimed invention so that they can be reformed into new metal powder-polymer composite sheets and used again.

In the specification, the term “casting surface” should be understood to mean a solvent-resistant and flexible sheet that acts a surface for casting the metal powder-polymer composite sheet. The casting surface helps speed up the metal powder-polymer composite sheet manufacturing process and once the metal powder-polymer composite sheet is manufactured it can be peeled off from the casting surface. Non-limiting examples of the casting surface material are Teflon® (polytetrafluoroethylene (PTFE)) film, polyimide films, polyester film, polyolefin film and polycarbonate.

In the specification, the term “green part” should be understood to mean parts that are sintered in controlled conditions, which results in the burnout of all the polymer and the formation of sinter necks between the metal powder particles, leading to a higher density part.

In the specification, the term “non-homogenous” should be understood to mean that the quantity of the polymer in the metal powder-polymer composite sheet is greater in the lower half (the first side) of the metal powder-polymer composite sheet when compared to the upper half (the second side). The upper half or top side of the metal powder-polymer composite sheet is typically metal powder rich (that is, it has a lower concentration or a lower quantity of polymer when compared to the lower half of the metal powder-polymer composite sheet); while the lower half or underside of the metal powder-polymer composite sheet is typically polymer rich (that is, it has the largest concentration or quantity of polymer when compared to the upper half of the metal powder-polymer composite sheet) (see FIG. 2(i) and FIG. 10). What this translates to is that there is a significant difference in the surface roughness of one side (top side) of the metal powder-polymer composite sheet when compared to the surface roughness of the other side (bottom side) of the metal powder-polymer composite sheet. A means for determining whether a metal powder-polymer composite sheet has a non-homogenous profile is by performing surface profilometry (Ra) tests on the so called “polymer side” (first or bottom side) and the “powder side” (second or top side) of a metal powder-polymer composite sheet. In the absence of any metal powder on a polymer sheet (see FIG. 15(a)), the Ra on the two surfaces (top and bottom sides) of the polymer sheet is very similar. As metal powder is loaded into the polymer sheet, the two Ra values start to differ significantly, by at least 5-10%, because the metal powder particles tend to agglomerate on one side (top side) of the metal powder-polymer composite polymer sheet (see FIG. 15(b)-(l)). The metal powder-polymer composite sheets are therefore non-homogeneous in cross-section when the Ra values on the top surface (second side) and the bottom surface (first side) differ. A non-homogeneous metal powder-polymer composite sheet can be defined as having a greater quantity of polymer in the lower half (towards the first side) of the metal powder-polymer composite sheet when compared to the upper half (towards the second side) of the same sheet, and where the smallest Ra value (measured at either the top (second) or bottom (first) sides) is less than about 60% of the largest Ra value (of the other side); optionally between about 10% and 30% of the largest Ra value. That is, wherein the smallest Ra value is less than about 59%, 58%, 56%, 54%, 53%, 50%, 48%, 46%, 44%, 42%, 40%, 38%, 36%, 34%, 32%, 30%, 28%, 26%, 24%, 22%, 20%, 19%, 18%, 17%, 16%, 15%, 14%, 13%, 12%, 11%, 10%, 9%, 8%, 7%, 6%, 5%, 4%, 3%, 2%, or 1% of the highest Ra value. A uniform or homogenous polymer distribution within the metal powder-polymer composite sheet would not lead to a considerably different Ra value (when the small Ra value is between about 65% and 100% of the larger Ra value) measured over the two sides (or surfaces), using the process described herein. This would lead to a homogenous metal powder-polymer composite sheet (see FIG. 11).

### BRIEF DESCRIPTION OF THE DRAWINGS

The invention will be more clearly understood from the following description of an embodiment thereof, given by way of example only, with reference to the accompanying drawings, in which:

FIG. 1 illustrates (a) a schematic diagram detailing the solvent casting process, and (b), the apparatus used to manufacture the metal powder-polymer composite sheets of the claimed invention.

FIG. 2 illustrates images of the metal powder-polymer composite sheets of the claimed invention (a) is an optical image of a typical stainless steel type 304 (SS304) powder-polymer composite sheet. (b) is an SEM image of SS304 powder-polymer composite sheet of the claimed invention showing the difference between the first and second side of the metal powder-polymer composite sheet. (c) is an SEM tilted view of the SS304 powder-polymer composite sheet of (b). (d) is a higher magnification of (c). (e) and (f) are SEM images of a tilted view of a copper powder-polymer composite sheet of the claimed invention. (g) and (h) are SEM images of a tilted view in cross-section of a titanium (Ti64) powder-polymer composite sheet of the claimed invention. (i) and (j) are SEM images of a tilted view in cross-section of an Inconel® (In718) powder-polymer composite sheet of the claimed invention. Inconel® is an austenitic nickel-chromium-based superalloy.

FIG. 3 illustrates (a) a schematic diagram of print/build plate configuration, (b) an optical image of a printed 50-layer square of SS304, (c) an SEM cross-sectional image in the XOZ plane of the SS304 square in (b).

FIG. 4 illustrates SEM and EDX analysis of SS304 powder-polymer composite sheet samples of the claimed invention. (a) Example area of interest (cross-section) for EDX study of MAPS SS304 powder-polymer composite sheet. (b) Combined image of EDX signals for carbon (orange) and iron (blue). (c) Individual iron (Fe) EDX signal. (d) Individual carbon (C) EDX signal.

FIG. 5 illustrates thermogravimetric analysis (TGA) of SS304 metal powder-polymer composite sheet using three different weight percentage of polycaprolactone polymer. The graph shows that the polymer degrades completely before 500° C. and metal powder content in all three sheets are above 94%.

FIG. 6 illustrates a micro-CT image of a segment of 50 layer MAPS metal powder-polymer composite sheet of the claimed invention. Coloured areas indicate pores, with the colour bar indicating the size of the pore.

FIG. 7 is a bar chart illustrating a microhardness result comparison for SS 304 powder-polymer composite sheet samples of the claimed invention produced by SLM and also by MAPS, both in the XOZ plane (side-view) and XOY plane (top-down).

FIG. 8 illustrates Electron BackScatter Diffraction (EBSD measurements of SS304 powder-polymer composite sheets of the claimed invention produced by SLM and MAPS. (a) XOZ section of SLM sample, (b) XOZ section of MAPS sample, (c) inverse pole figure (IPF) for SLM sample, (d) IPF for MAPS sample (e) IPF key.

FIG. 9 shows an SEM tilted image of a cross-section edge of a metal powder-polymer composite sheet of the claimed invention, wherein SS304 is cast in a polycaprolactone in chloroform solution. The metal powder-polymer composite sheet is approximately 100 μm thick. The metal powder element of the metal powder-polymer composite sheet is the dominant material, with the polymer fraction being less dominant. The polymer is dominant towards one surface of the metal powder-polymer composite sheet (amounting to >60% of the volume of the polymer fraction; the underside), while the metal powder is relatively homogeneous through the composite sheet. This phenomenon has the effect of increasing the polymer fraction at the underside and reducing the polymer fraction at the topside, resulting in a non-homogenous composition of the metal powder-polymer composite sheet due to the increased concentration or quantity of polymer towards the first side (the underside) in the lower half of the metal powder-polymer composite sheet.

FIG. 10 shows a tilted SEM image of a cross-section edge of a metal powder-polymer composite sheet of the claimed invention, wherein SS304 was cast in a nitrocellulose in acetone solution. The metal powder-polymer composite sheet is approximately 80-120 μm thick. The polymer is dominant towards the underside (first side) surface of the metal powder-polymer composite sheet (amounting to >60% of the volume of the polymer fraction of the sheet in the underside (first side) resulting in a non-homogenous composition in cross section, while the metal powder is relatively homogeneous in cross section through the metal powder-polymer composite sheet. This phenomenon has the effect of increasing the polymer fraction at the underside (towards the lower half of the metal powder-polymer composite sheet) and reducing the polymer fraction at the topside.

FIG. 11 shows an SEM image of a metal powder-polymer composite sheet within the same sheet thickness as shown in FIG. 10, wherein SS304 was cast in a polyvinylidene fluoride in acetone solution. The sheet is approximately 80-120 μm thick. The quantity of the polymer as illustrated here is dominant towards both surfaces of the metal powder-polymer composite sheet (both the underside and topside) and less at the centre. In this case the polymer fraction is higher at both surfaces and lower in the centre of the metal powder-polymer composite sheet. This is an example of a homogenous sheet and is given by way of comparison to the typical non-homogeneous metal powder-polymer composite sheets of the claimed invention described in this specification.

FIG. 12 shows (a) an SEM image of the topside (the second side) of the metal powder-polymer composite sheet of FIG. 11, while (b) shows an SEM image of the underside (the first side) of the metal powder-polymer composite sheet of FIG. 11. It is possible to see the polymer material from both the topside (second side) and underside (first side) of the metal powder-polymer composite sheet. Note that the Ra value of the topside (second side) will be similar to the Ra value of the underside (first side).

FIG. 13 shows SEM images of cross-section examples of a build-up of multiple layers of the claimed MAPS process (in this case the melting point of the powder material was reached) where either the underside was facing the build plate (left image) or the topside was facing the build plate (right image) during the layer build-up, showing clear differences in weld geometry depending on the metal powder-polymer composite sheet orientation. The material below the dashed line is the build plate. Both examples in FIG. 13 used SS304 metal powder-polymer composite sheets, 15 layers were printed with 85W laser power, at 100 mm/s scan speed, and 140 μm hatch distance. When the underside faces the build plate (the image on the left) the resultant build is highly uneven and shows evidence of significant voids. When the topside faces the build plate (the image on the right) the resultant build is much more even and appears to be relatively denser. The metal powder-polymer composite sheet setup described above has proven to be advantageous for the purpose of constructing shapes with minimal pores using MAPS. This is because this setup seems to facilitate evaporation and degradation of the polymer from the area of the metal powder-polymer composite sheet to the ambient, in turn contributing to a cleaner weld.

FIG. 14 shows in (a) and (c) SEM images, in tilt view, in cross-section of an SS304 powder-polymer composite sheet of the claimed invention, while (b) and (d) show SEM images in cross-section of an SS304 powder-polymer composite sheet of the claimed invention that has been recycled from scraps of SS304 powder-polymer composite sheets of the claimed invention.

FIG. 15 are surface (line) profilometry (Ra) tests on metal powder-polymer composite sheets of the claimed invention, where (a) shows Ra values for both sides the metal powder-polymer composite sheet where no metal powder is present, (b) shows Ra values for both sides the metal powder-polymer composite sheet where 10 mg of metal powder is present, (c) shows Ra values for both sides the metal powder-polymer composite sheet where 20 mg of metal powder is present, (d) shows Ra values for both sides the metal powder-polymer composite sheet where 30 mg of metal powder is present and (e) shows Ra values for both sides the metal powder-polymer composite sheet where 40 mg of metal powder is present.

### DETAILED DESCRIPTION OF THE DRAWINGS

### Materials and Methods

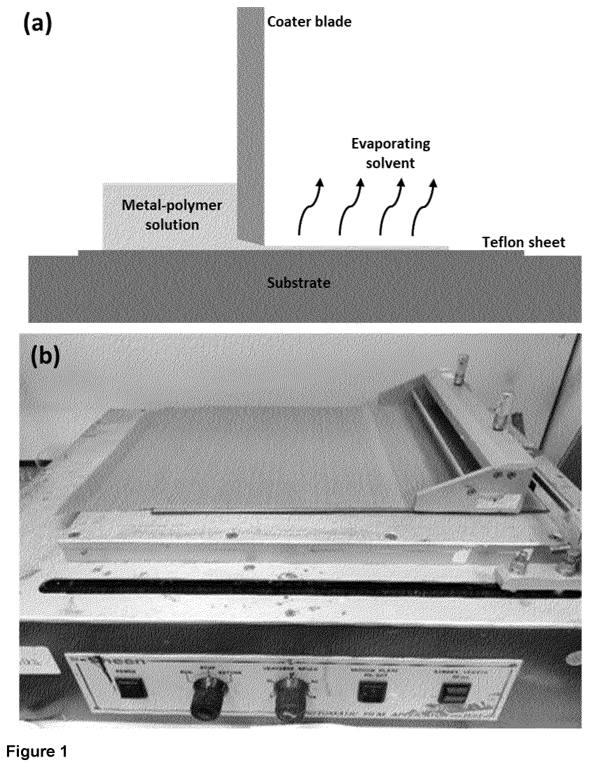

The metal powder-polymer composite sheets were fabricated via solvent casting. A schematic diagram of the process can be seen in FIG. 1. 40 g SS304 powder (Carpenter Additive) was mixed with a 10 mL solution of polycaprolactone (PCL, 14 wt %), dissolved in chloroform (Sigma Aldrich). PCL can be used at a concentration of between about 5 wt % to about 30 wt %. The metal-polymer solution was dispensed along the sidewall of an immobilised 90° bevelled razor blade onto a Teflon™ (polytetrafluoroethylene (PTFE)) sheet placed over the substrate. The metal-polymer solution was dragged by a casting knife or a doctor blade coater at a controlled speed (50 mm/s) to spread the dispersed metal-polymer solution uniformly on the Teflon™ sheet. The entire process to produce an A4-sized sheet took 10 mins. the coating step took seven seconds and the remainder of the process was taken up with solvent evaporation/drying time. The quantities given above result in a roughly A4-sized metal powder-polymer composite sheet that was 100±10 μm thick.

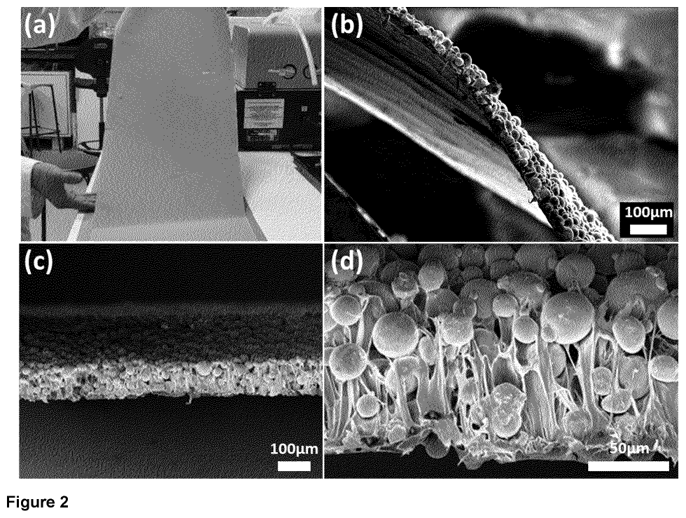

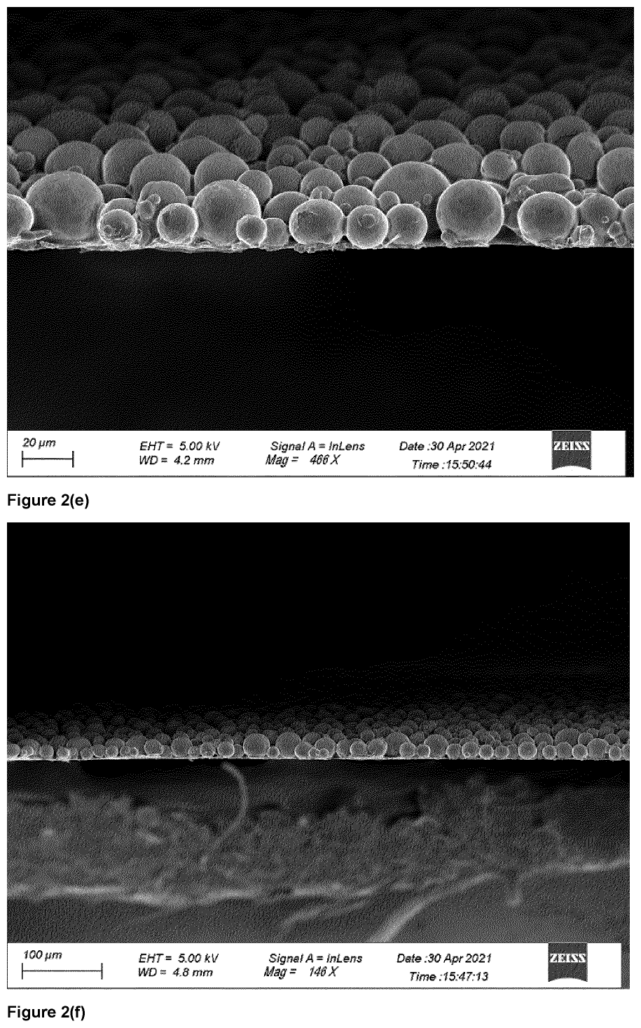

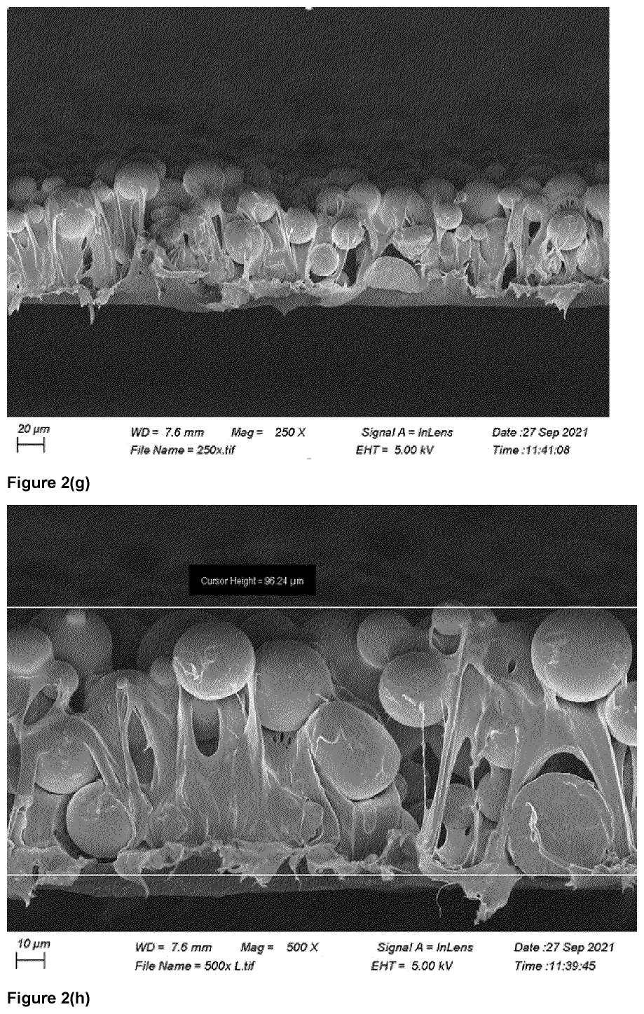

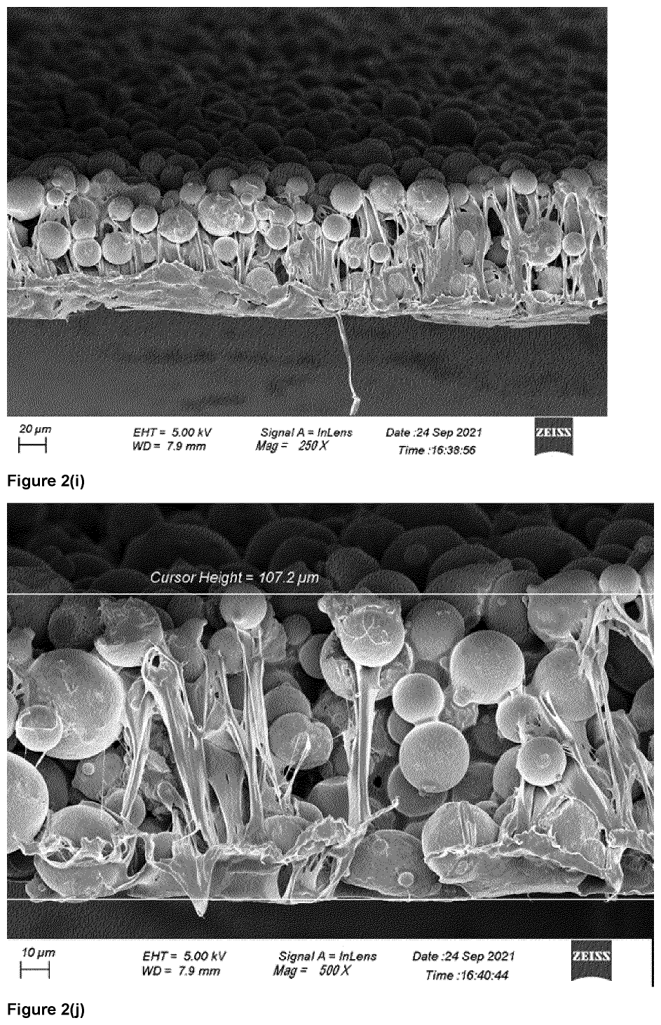

A typical metal powder-polymer composite sheet is shown in FIG. 2(a). Each metal powder-polymer composite sheet is distinguished by a light grey colour, and each side of the sheet felt different to touch. The side that was in contact with the Teflon™ will feel smooth (the underside), whereas the opposite side (or topside) will feel slightly rougher. The reason for this is due to the Teflon™ and chloroform being non-polar, resulting in an attraction which draws the solvent (and the polymer dissolved within it) closer to the Teflon™-side (casting surface) of the metal-polymer mixture. The result of this is shown more clearly through SEM imaging (FIG. 2(b)). In FIG. 2(b), a typical 304 SS powder-polymer composite sheet is bent in such a way that the differences in texture between each side of the sheet can be observed. The underside that is in contact with the Teflon™ is confined during the manufacturing process and shows no exposed powder, whereas the opposite side is not confined and has the powder relatively exposed, which explains the relatively rough texture. Despite the relatively rough topside, there has been no evidence that the powder can get loose from the metal powder-polymer composite sheet. This is made clear by looking at the cross-section of the metal powder-polymer composite sheets (FIG. 2(c), (d)). FIG. 2(e), 2(f) shows the cross section of the copper powder-polymer composite sheet, FIG. 2(g), 2(h) shows the cross-section of Ti64 powder-polymer composite sheet, where the Ti64 is mixed in a 10 ml solution of PCL at 25 wt %, while FIG. 2(i) 2(j) shows the cross section of In718 powder-polymer composite sheet, where the In718 is mixed in a 10 ml solution of PCL at 20 wt %), The metal powder-polymer composite sheets of the claimed invention can have different thickness depending on the metal used, but the morphology of the material remains the same, irrespective of the type of metal used. The geometrical characteristics of the metal powder-polymer composite sheets will be consistent.

Even the most exposed powder particles at the surface of the metal powder-polymer composite sheet are in significant contact with the PCL, thus maintaining the integrity of the metal powder-polymer composite sheet as a whole.

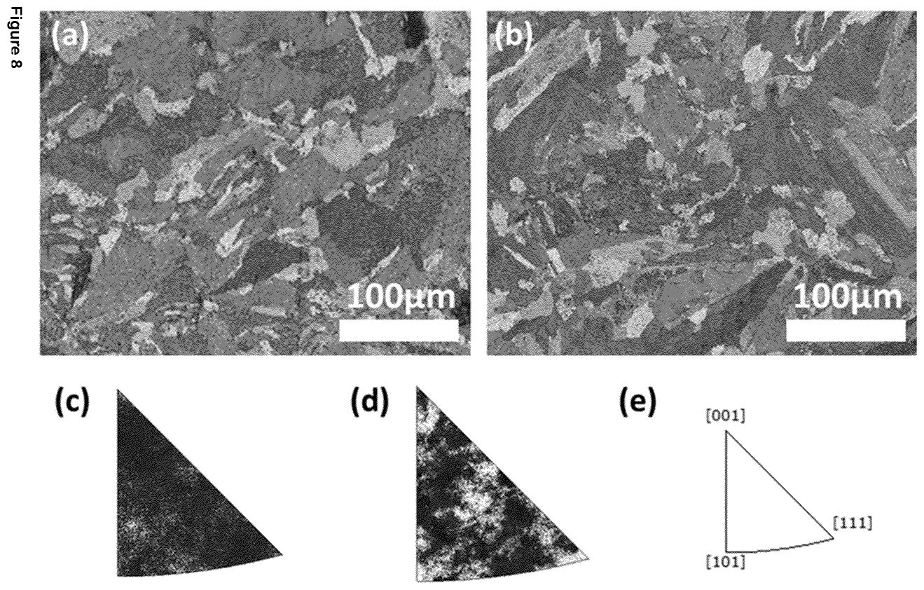

Tests for the MAPS process were performed using a Realizer SLM 50. The powder recoating mechanism was removed from the build chamber, making room for the metal powder-polymer composite sheets to be placed inside and not be disturbed during the process. The machine uses a 100 W continuous wave fibre laser with a variable spot size in the range of between about 20 μm and about 200 μm. The Realizer SLM 50 has a build space of 70 mm diameter and 40 mm height with each layer height in the range of ˜30 μm. The LPBF control sample and the MAPS sample (comparative results shown in FIGS. 7 and 8) were both fabricated under an argon atmosphere with a laser power of 85 W, a scan speed of 100 mm/s, and a hatch spacing of 100 μm. The hatch pattern for all prints was a simple raster scan with rotated by 30° for each subsequent layer. For each layer, the metal powder-polymer composite sheet was moved by hand via the glove ports installed on the Realizer SLM 50, so as to not require a complete purging of the argon in the chamber. The build plates used for printing were manufactured from metal powder-polymer composite sheets of 304 SS (Goodfellow).

Scanning electron microscopy (SEM) of printed materials was carried out using a Zeiss ULTRA scanning electron microscope equipped with a GEMINI FESEM column capable of 1 nm resolution at 15 kV, using the SE2 detector. The beam voltage was 5 kV for all images. EDX analysis was carried out using a 20 mm2 Oxford Inca EDX detector with an energy resolution of 129 eV, with each measurement occurring at a beam voltage of 16kV. Samples were prepared for cross-sectional analysis by bisecting with a Excetek V440G EDM, and then mounting in a cylinder of conductive resin. The mounted samples were polished using a Mekton polishing unit set to 150 RPM and 30 N, starting in 4 steps of gradually finer polishing paper (320-1200), followed by polishing with a diamond suspension, and finally for 10 mins with a silica suspension. Microhardness measurements were carried out using a Mitutoyo MVK-H1 microhardness tester. Measurements were repeated 10 times and averaged. Macroscopic optical images of the metal-powder sheet, etc., were taken using the in-built camera of an iPhone SE.

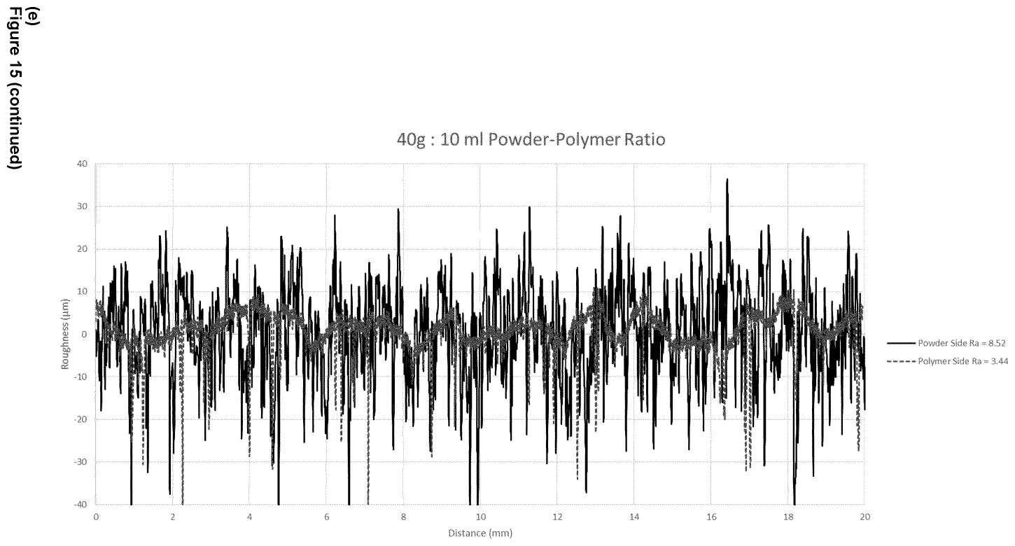

Surface profilometry (Ra) tests were performed on the metal powder-polymer composite sheet of the claimed invention. The Ra values were measured over a line scan experiment by using a setup with a Keyence Confocal sensor for profilometry data acquisition. In brief, a metal powder-polymer composite sheet is placed flat on the measurement bed; the Keyence CL-3000 series confocal sensor is focused onto the metal powder-polymer composite sheet; a measurement of length of 20 mm is taken along the y-axis of the metal powder-polymer composite sheet (at a speed of 0.5 mm/s, acceleration at 1 mm/s 2, and a ramp distance of 0.5 mm); and the wave profile output from the Keyence CL-3000 series sensor is processed by a Gaussian filter MATLAB script to calculate the surface roughness value (Ra). The Ra values can be seen in FIG. 15. Other methods of measuring the Ra values can also be used such as profilometry and Atomic Force Microscopy methods, and other methods known to those skilled in the art.

### Results and Discussion

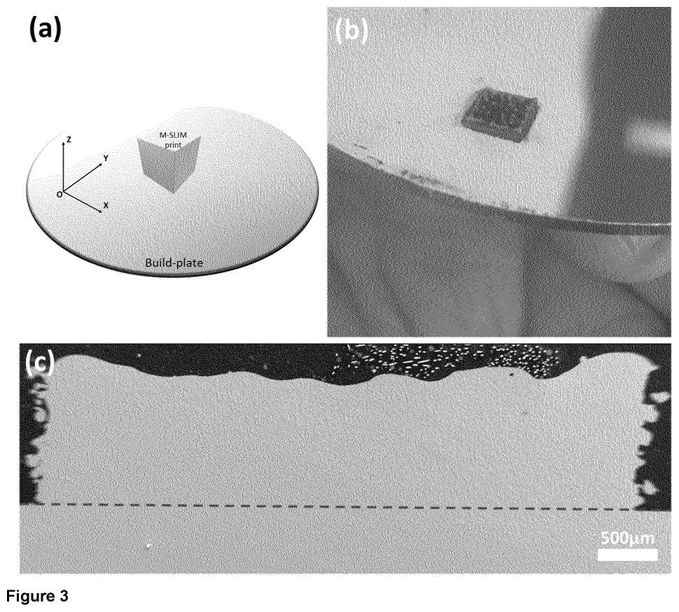

All MAPS prints were initially designed as cubes (FIG. 3(a)) but due to the prototype setup employed, it was not possible to complete the shape in the z-axis. A typical print is shown in FIG. 3(b): specifically, a 50-layer print. The height of the print is ˜1 mm (FIG. 3(c)), which indicates an average layer height of 20 μm.

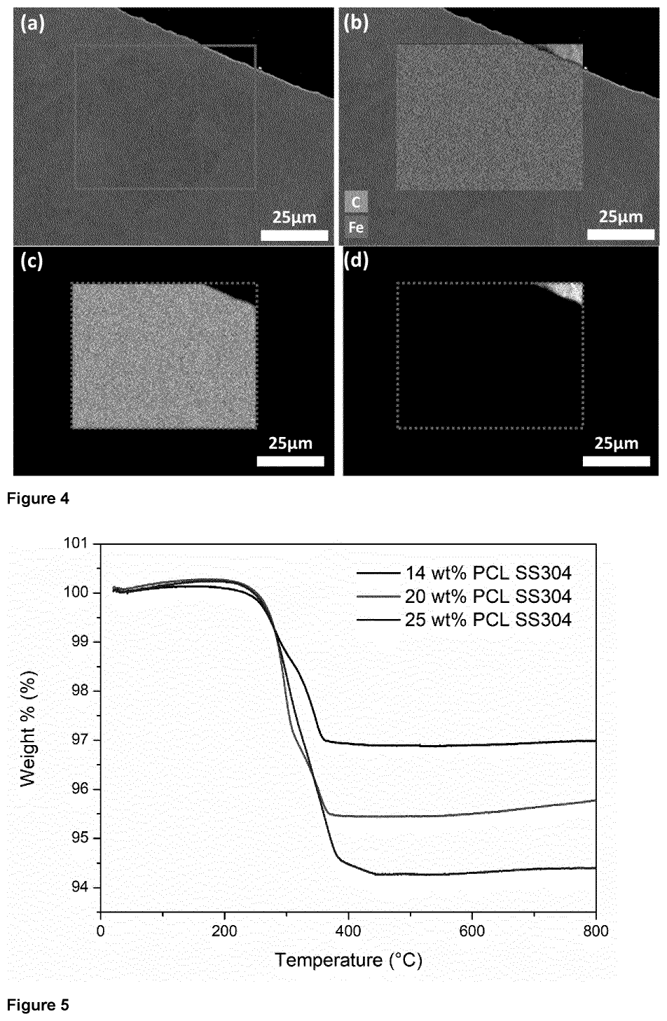

To rule out any significant contamination in the printed parts from the polymer binder, EDX studies were performed. The main results can be seen in FIGS. 4(c) and 4(d). FIG. 4(a) specifies a representative area of investigation: an area of 3685 μm² close to the surface of the build. FIG. 4(b) shows the map of EDX signals for 2 demonstrative elements: Fe (which makes up the majority of 304 SS) and C. The map shows that there is no significant C signal within the Fe matrix: the only presence of C can be found from the conductive resin surrounding the sample. It can thus be inferred that the polymer is completely broken down during the MAPS printing process. This means the polymer is completely removed from the printed part due to the relatively low melting temperature of PCL.

The results of a TGA analysis on the flexible and recyclable metal powder-polymer composite sheet at variable PCL compositions is shown in FIG. 5. PCL is shown to degrade fully at a temperature between 400° C. and 500° C., which is less than the metallic powder melting temperature that is required for full material consolidation. The polymer does not take part in the consolidation process. The advantage of this is that there is no polymer contamination in the printed part.

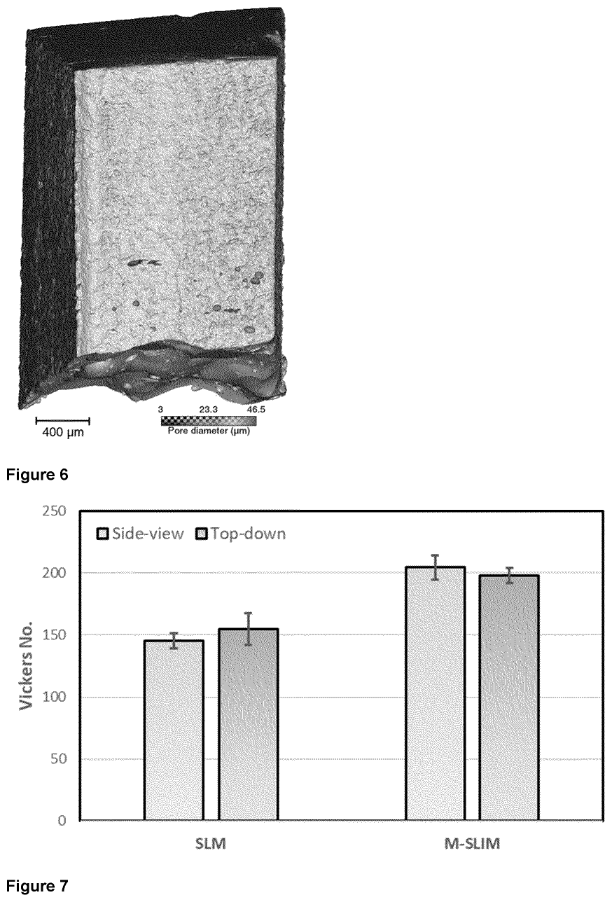

The relative density of a part produced by LPBF was measured via microCT (FIG. 6), as the prototyping process described above did not allow for the production of samples large enough for Archimedes testing. MicroCT measurements indicated a total porosity of 0.0235%, which hence indicates a relative density of 99.9765%. By contrast, the relative density of the LPBF part was found (via Archimedes testing) to be 99.93%, showing that MAPS capable of improving on the density obtainable from tradition PBLF processing.

To determine how the mechanical properties of the MAPS printed parts compare with LPBF parts, microhardness measurements were undertaken (FIG. 7). Compared to the standard Vickers hardness value for 304 SS of 149, the LPBF sample is well within that value. The sample also displays a minor anisotropy in that the hardness in the XOY direction (the build direction) is slightly higher than the XOZ direction (the scan direction). The MAPS sample, however, exhibits a significantly higher hardness, both in the XOZ and XOY directions. The MAPS sample differs from the LPBF sample also in that, while it also exhibits a minor anisotropy, the hardness in the scan direction is higher than that of the build direction.

Part of the reason behind this discrepancy in microhardness values may be elucidated by the crystallography of the samples (FIG. 8(a), 8(b)). Electron BackScatter Diffraction (EBSD) studies of the LPBF (FIG. 8(a)) and MAPS (FIG. 8(b)) samples were performed in order to determine the average grain size and whether any crystallographic texture is present. A marked difference in the grain sizes between each sample was present: 48.7 μm (from 1878 grains) for the PBLF sample, and 29.2 μm (from 958 grains) for the MAPS sample. It has previously been shown that larger grain sizes will often result in lower hardness values, but the significant differences in porosity will also likely have influence.

In terms of crystallographic texture, neither sample demonstrated having any texture (FIG. 8c-e). The inverse pole figures show that the crystallites do not favour any orientation, and the possible orientations are evenly spread out.

To confirm the thickness and observe the differences between the recyclable metal powder-polymer composite sheets made using three different polymer binders, cross sectional SEM images were obtained.

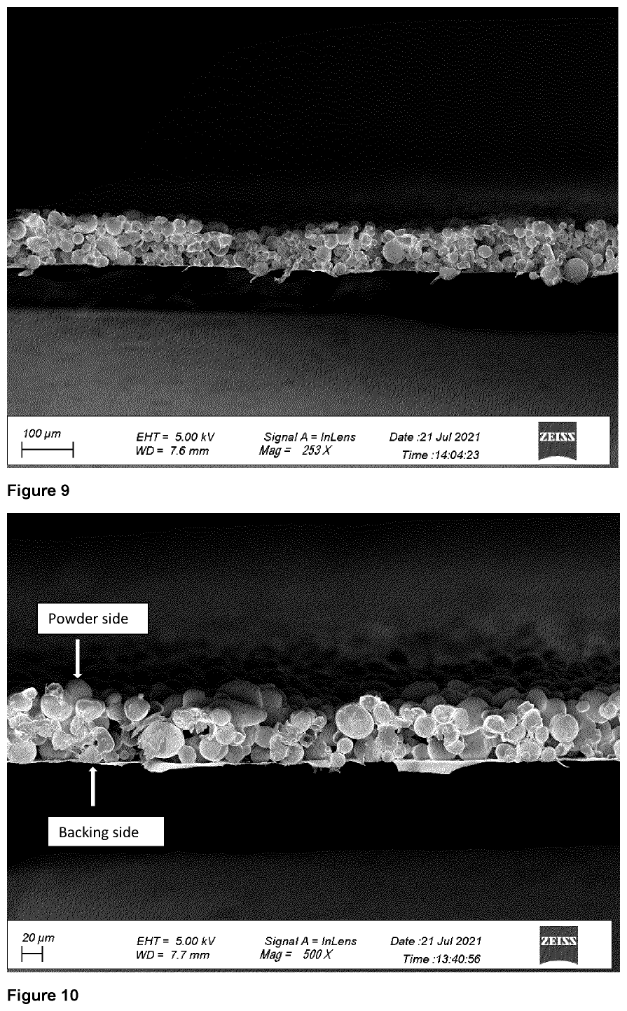

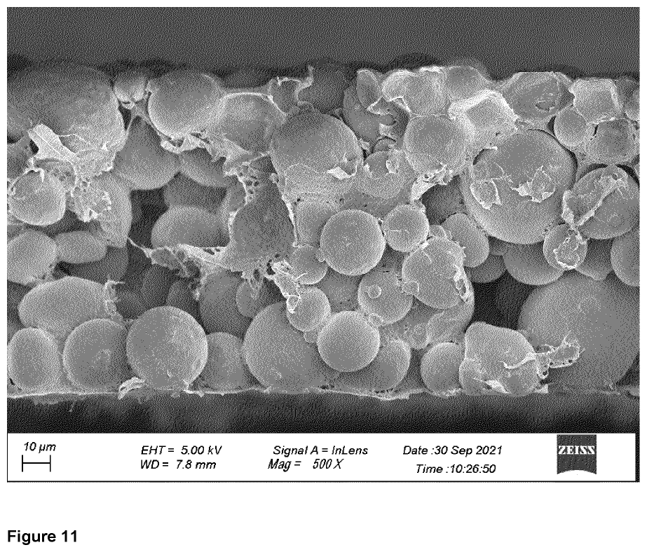

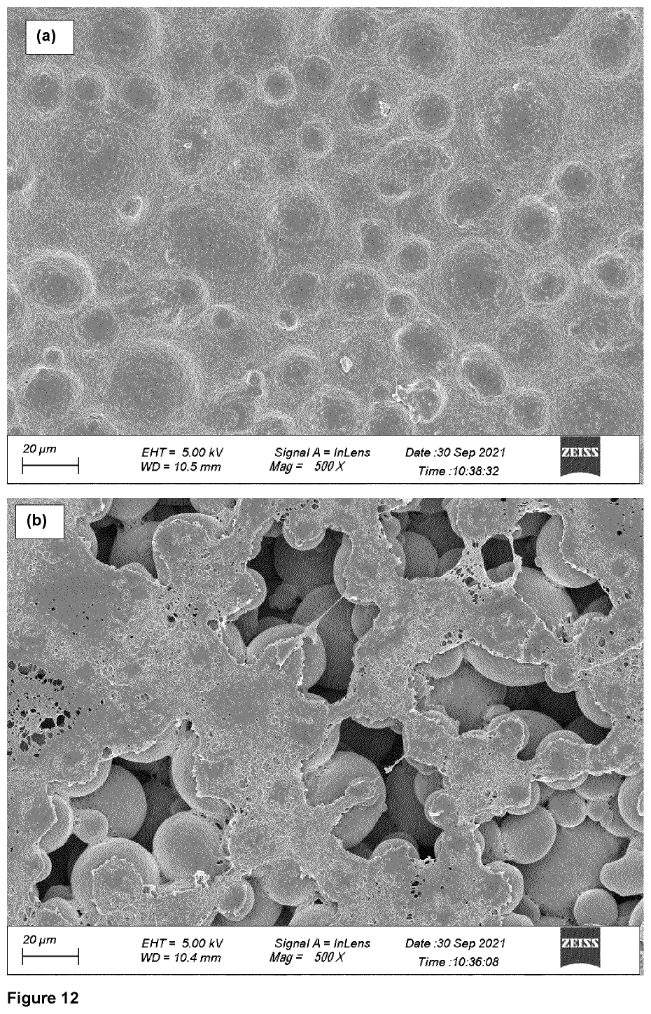

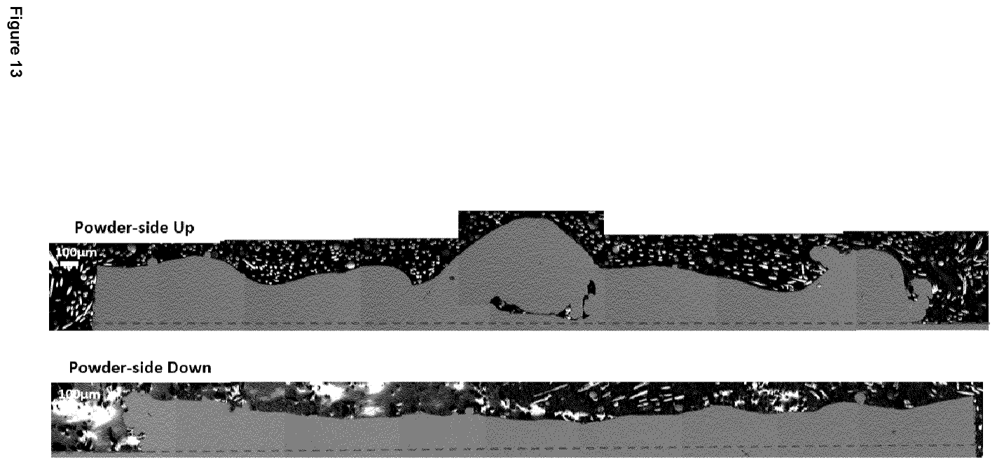

Metal powder-polymer composite sheet made with polycaprolactone (FIG. 9) and nitrocellulose (FIG. 10) revealed that they have a low polymer fraction on the top side, which is exposed to the atmosphere, and have high polymer fraction on the casting surface side (underside). These are examples of non-homogeneous metal powder-polymer composite sheets, for which a definition was provided above. Whereas a metal powder-polymer composite sheet shown in FIG. 11 made with polyvinylidene fluoride has a higher quantity of polymer on both the top side and the bottom side, indicating a metal powder-polymer composite sheet with a homogenous composition. Top-down SEM images (FIG. 12(a), 12(b)) of the metal powder-polymer composite sheet of FIG. 11 confirms that the metal powder-polymer composite sheet has a higher quantity of polymer on both sides.

The metal powder-polymer composite sheets of the claimed invention can be used in the MAPS process to build up multiple metal layers where either (i) the melting point of the material is reached, or (ii) where the melting point of the material is partially reached, in order to achieve the formation of a green body. That green body can be subsequently sintered to achieve a part with a density value between 90% and 100%. The metal powder-polymer composite sheets can be employed in the MAPS process with either the topside facing the build plate or the underside facing the build plate, showing clear differences in weld geometry depending on orientation (see FIG. 13). In FIG. 13, the material below the dashed line is the build plate. Both printed parts shown in FIG. 13 are 304 stainless steel, 15 sheet layer prints, printed with 85 W power, 100 mm/s scan speed, 140 μm hatch distance. When the underside of the metal powder-polymer composite sheet faces the build plate (the image on the left) the printed part is highly uneven and shows evidence of significant voids. A non-homogeneous metal powder-polymer composite sheet is advantageous in this respect. When the side of the metal powder-polymer composite sheet with the highest metal particle concentration, coinciding with the side with the highest Ra value, faces the build plate (the image on the right) the printed part is much more even and appears to be relatively denser. The setup described above has proven to be advantageous for the purpose of constructing these 3-dimensional shapes. When considering the process of casting one layer of the composite material on top of another layer of cast composite material and processing the casted layers with a laser, having the powder side of the metal powder-polymer composite sheet facing towards the build plate is advantageous as it can lead to a more accurate print. This is because this setup seems to facilitate evaporation of the polymer from the area of the metal powder-polymer composite sheet to the ambient, in turn contributing to a cleaner weld.

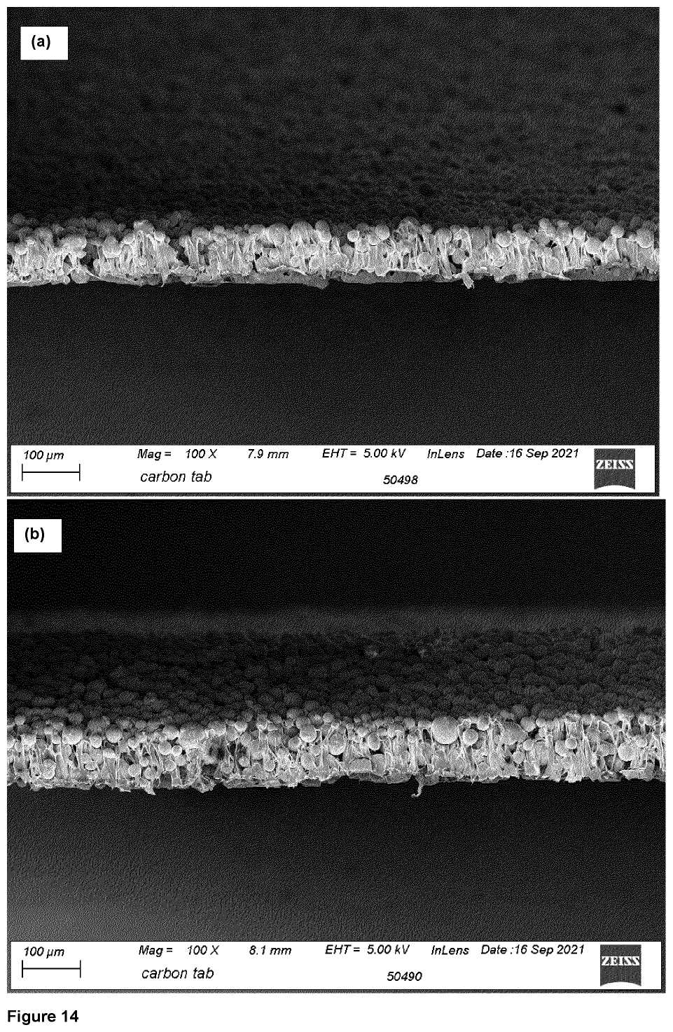

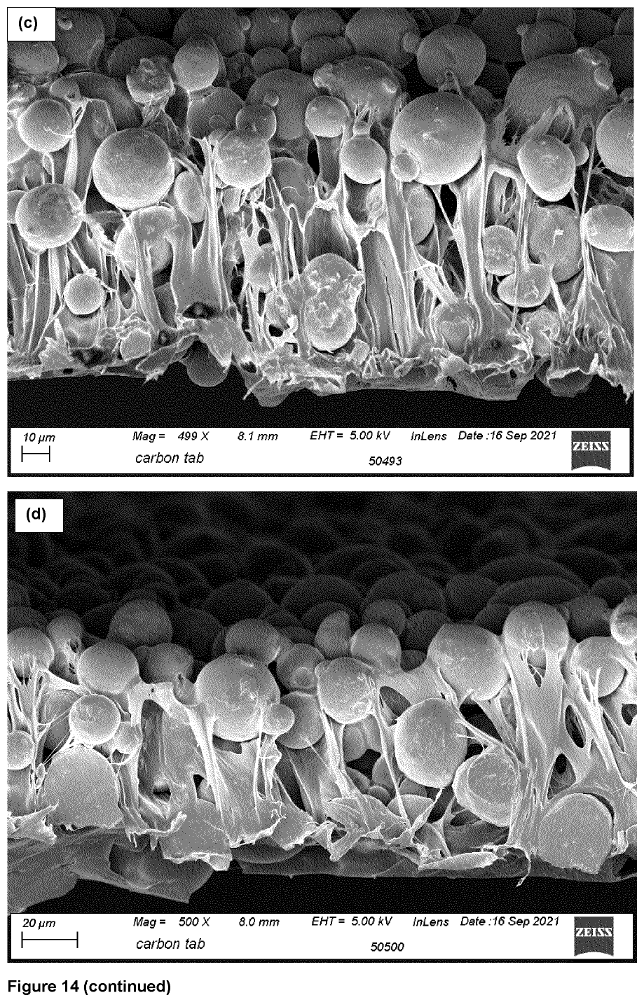

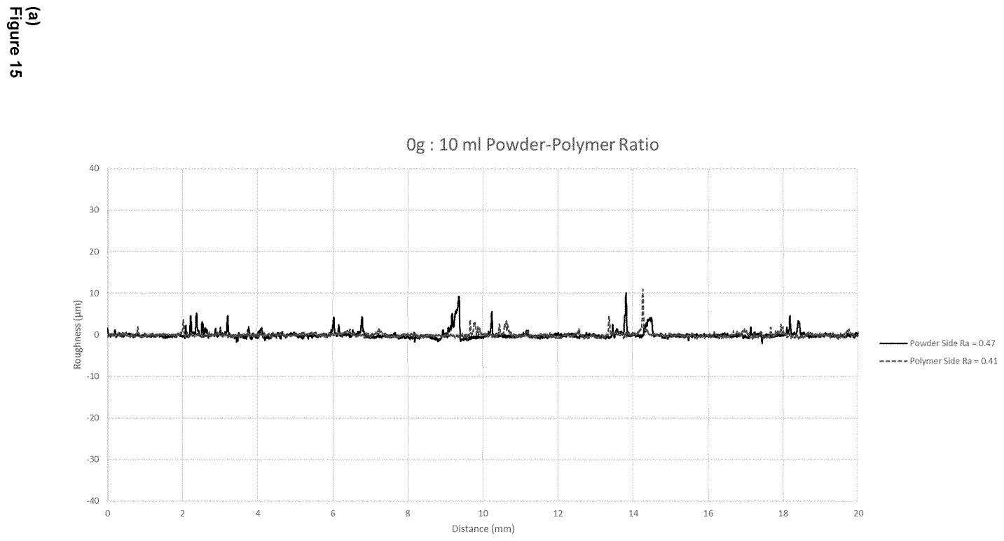

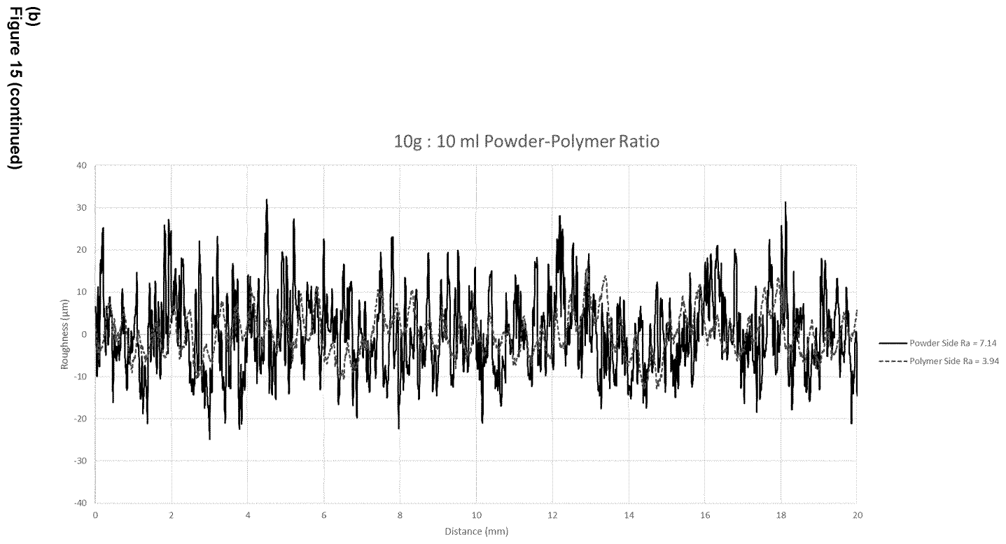

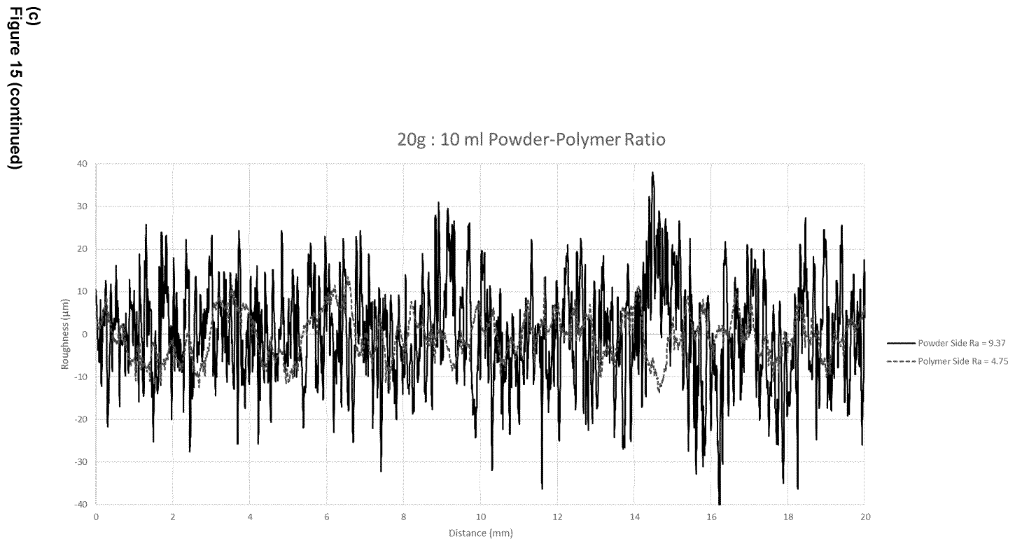

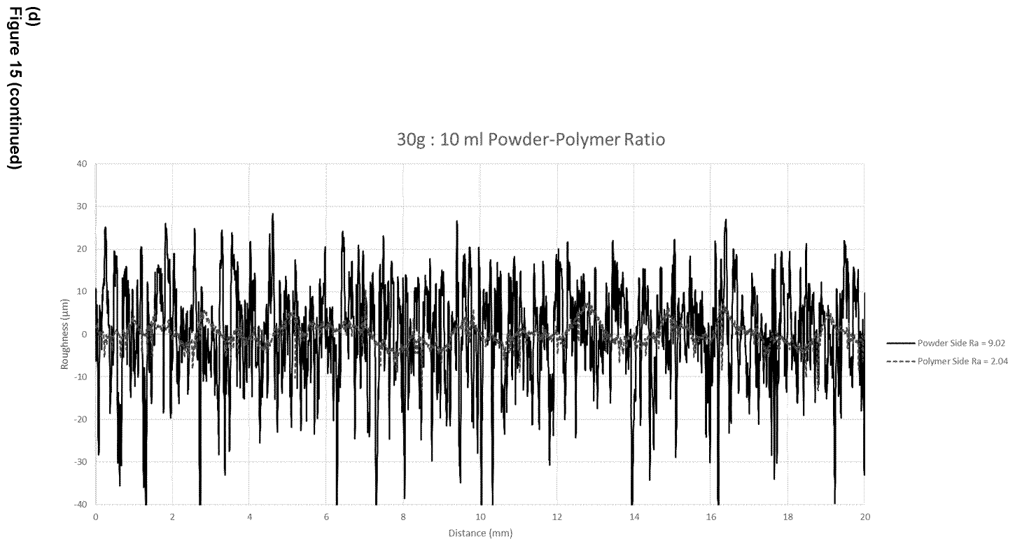

40 g of scraps/remnants of pre-used metal powder-polymer composite sheets made with polycaprolactone polymer were collected and added into 10 ml of chloroform solvent, and the mixture was cast onto a PTFE sheet to obtain a recycled metal powder-polymer composite sheet. FIGS. 14(b) and 14(d) confirms that the recycled metal powder-polymer composite sheets are powder rich on top side and polymer rich on the (other) bottom side (non-homogenous in cross section) and appear similar to the original manufactured sheet.

To determine the surface profilometry of the metal powder-polymer composite sheets of the claimed invention, varying ratios of metal powder in a polymer solution (g:ml; w/v) were tested (see FIG. 15). FIG. 15 shows how the surface profilometry varies at different polymer to metal powder ratio concentrations used to make the metal powder-polymer composite sheets. There is a very small difference between the two sides (first and second sides) of the metal powder-polymer composite sheet when the metal content is zero; up to the largest difference reported in FIG. 15(d), where the smallest Ra (on the first side/underside/polymer-rich side) is approximately 22.6% of the highest Ra (of the second side/top side/powder side). Hence, the metal powder-polymer composite sheet is considered to be non-homogeneous in cross-section as shown by the polymer-rich lower half of the metal powder-polymer composite sheet, and confirmed by the surface roughness test where the smallest Ra value is less than 60% of the highest Ra value. There are printing advantages when operating with non-homogeneous metal powder-polymer composite sheets, as shown in FIG. 13.

The MAPS additive manufacturing method is a potentially game-changing alternative to traditional LPBF methods. As an alternative feeder material, the metal powder-polymer composite sheets are easy to produce, safe to handle, require little clean-up, and allow a much greater degree of flexibility in terms of changing materials during the printing process. Importantly, it has been shown that the MAPS printed parts compare very well with powder based LPBF printed samples. The MAPS samples appear to be fully dense, and they exhibit a higher microhardness measurement value.

In the specification the terms “comprise, comprises, comprised and comprising” or any variation thereof and the terms “include, includes, included” and including” or any variation thereof are considered to be totally interchangeable and they should all be afforded the widest possible interpretation and vice versa.

The invention is not limited to the embodiments hereinbefore described but may be varied in both construction and detail.

1. A recyclable and flexible metal powder-polymer composite sheet, the metal powder-polymer composite sheet comprising at least one metal powder and at least one polymer, and wherein the metal powder-polymer composite sheet has an increased polymer to metal powder ratio at a first side when compared to a second side of the metal powder-polymer composites sheet, providing a non-homogenous composition in cross-section.

2. The recyclable and flexible non-homogenous metal powder-polymer composite sheet of claim 1, wherein the first side of the metal powder-polymer composite sheet has a surface roughness (Ra) value less than about 60% of a higher Ra value of the second side of the metal powder composite sheet.

3. The recyclable and flexible metal powder-polymer composite sheet of claim 1 or claim 2, wherein the ratio of the densities of the polymer solution to the metal powder is between about 1:5 to about 1:10 gcm⁻³.

4. The recyclable and flexible metal powder-polymer composite sheet of any one of the preceding claims, wherein the ratio of the densities of the polymer solution to the metal powder is 1:7 gcm⁻³.

5. The recyclable and flexible metal powder-polymer composite sheet of any one of the preceding claims, wherein the metal content in the metal powder-polymer composite sheet is between about 80 wt % and about 99 wt %.

6. The recyclable and flexible metal powder-polymer composite sheet of claim 5, wherein the metal content in the metal powder-polymer composite sheet is between about 92 wt % and about 96 wt %.

7. The recyclable and flexible metal powder-polymer composite sheet of any one of the preceding claims, further comprising a removable casting surface.

8. The recyclable and flexible metal powder-polymer composite sheet of any one of the preceding claims, wherein the polymer is selected from polycaprolactone, cellulose acetate, cellulose ester, polyester, polyurethane, polyethylene, polypropylene, polyvinylchloride (PVC), polyvinylidene fluoride (PVDF), fluoroplastics, polyether amide, polylactic acid (PLA), polycaprolactone (PCL), nitrocellulose, cellulose, cellulose acetate, polybutylene succinate (PBS), polyhydroxyalkanoate (PHA), and poly(3-hydroxybutyrate-co-3-hydroxyhexanoate).

9. The recyclable and flexible metal powder-polymer composite sheet of any one of the preceding claims, wherein the metal powder is selected from stainless steel, tungsten, titanium, titanium alloys, aluminium, aluminium alloys, copper, nickel, nickel alloys, Silver, Gold, Platinum, Lithium, Beryllium, Magnesium, Zinc, Zirconium, Niobium, Tungsten, Tin, Lead, and their alloys, super alloys, high entropy alloys, cobalt-chrome, barium, molybdenum, NiTi (nitilon), NiTi alloys, ceramic materials, metal-ceramic composites, metal-diamond composites, tantalum, tantalum carbide, and combinations thereof.

10. The recyclable and flexible metal powder-polymer composite sheet of any one of the preceding claims, wherein the first side of the metal powder-polymer composite sheet is higher in polymer content when compared to the second side of the metal powder-polymer composite sheet.

11. A recyclable and flexible, metal powder-polymer composite sheet, the metal powder-polymer composite sheet comprising at least one metal powder and at least one polymer, wherein the metal powder-polymer composite sheet has an increased polymer to metal powder ratio at a first side of the metal powder-polymer composite sheet when compared to a second side providing a non-homogenous composition in cross-section, and wherein the first side of the metal powder-polymer composite sheet has a surface roughness (Ra) value of less than about 60% of a higher Ra value of the second side of the metal powder-polymer composite sheet.

12. A method of manufacturing the recyclable and flexible metal powder composite sheet of claim 1, the method comprising the steps of:
dissolving between about 8 wt % and about 50 wt % of a polymer in an organic solvent to form a polymer solution;
dispersing at least one metal powder in the polymer solution in a ratio of polymer solution to metal powder of about 2 ml:10 g v/w to about 9 ml:2 g v/w to form a metal-dispersed solution;
casting the metal-dispersed solution on to a casting surface; and
drying the cast metal-dispersed solution to form the recyclable and flexible metal powder composite sheet.

13. The method of claim 12, wherein the organic solvent is selected from acetone, chloroform, N-methyl formamide, tetrahydrofuran, cyclohexane, dimethylacetamide, dimethylsulphoxide, dimethylformamide, butanol, ethanol, methyl ethyl ketone, and diacetone alcohol.

14. The method of claim 12 or claim 13, wherein the polymer is selected from polycaprolactone, polytetrafluoroethylene, cellulose acetate, cellulose ester, polyester, polyurethane, polyethylene, polypropylene, polyvinylchloride (PVC), polyvinylidene fluoride (PVDF), fluoroplastics, polyether amide, polylactic acid (PLA), polycaprolactone (PCL), nitrocellulose, cellulose, cellulose acetate, polybutylene succinate (PBS), polyhydroxyalkanoate (PHA), and poly (3-hydroxybutyrate-co-3-hydroxyhexanoate).

15. The method of any one of claims 12 to 14, wherein the polymer solution is between about 5 wt % and about 30 wt % polycaprolactone in chloroform.

16. The method of claim 15, wherein the polymer solution is about 14 wt % polycaprolactone in chloroform.

17. The method of any one of claims 12 to 14, wherein the polymer solution is between about 5 wt % and about 30 wt % polytetrafluoroethylene in acetone.

18. The method of claim 17, wherein the polymer solution is about 20 wt % polytetrafluoroethylene in acetone.

19. The method of any one of claims 12 to 18, wherein the cast metal dispersed solution is dried at room temperature.

20. The method of any one of claims 12 to 19, further comprising the step of adding the metal powder-polymer composite sheet in a solvent to form a recycled metal powder-polymer solution, casting the recycled metal powder-polymer solution onto the casting surface; and drying the cast recycled metal powder-polymer solution to form the recyclable and flexible metal powder composite sheet.

21. A method for printing an object using the recyclable and flexible metal powder-polymer composite sheet of any one of claims 1 to 11, the method comprising the steps of:
(i) applying the recyclable and flexible metal powder-polymer composite sheet on a build plate, with the second side of the metal powder-polymer composite sheet facing the build plate;
(ii) applying heat to composite sheet until a fusion temperature of the metal powder is achieved;
(iii) removing the metal powder-polymer composite sheet which was not affected by the heat application from the area or optionally re-centering an untreated portion of the heated metal powder-polymer composite sheet on the build plate for depositing a further layer of metal; and
(iv) adding a new metal powder-polymer composite sheet when the previous metal powder-polymer composite sheet is no longer required, and repeat the steps (i) to (iii) until the object is achieved.

22. The method of claim 21, wherein the heat is generated by a heat source selected from an infrared radiation device, a laser, an electron beam, an ion laser, an arc, plasma, an induction heater, a hot plate, and a combination thereof.

23. The method of claim 22, wherein the laser is selected from a CO₂ laser, a 1064 nm infrared Nd:YAG laser, an infrared fibre laser, a diode laser, an argon laser, a krypton laser, an argon/krypton laser, a helium-cadmium laser, a copper vapor laser, a xenon laser, an iodine laser, an oxygen laser, and an excimer laser.

24. The method of any one of claims 21 to 23, wherein the step (iv) can be replaced with, or followed by step (v), recycling any scraps of the previous metal powder-polymer composite sheet and adding the recycled metal powder-polymer composite sheet when the previous metal powder-polymer composite sheet is no longer required, and repeat the steps (i) to (iii) until the object is achieved.
